(19) United States
(12) Patent Application Publication
(10) Pub. No.: US 2025/0388765 A1
(43) Pub. Date: Dec. 25, 2025

(54) Water Washable Ink or Paint

(71) Applicant: Crayola LLC, Easton, PA (US)

(72) Inventors: Michael Moskal, Pottstown, PA (US); Keith Allison, Blandon, PA (US); Michael L. Spera, Mohnton, PA (US)

(73) Assignee: Crayola LLC, Easton, PA (US)

(21) Appl. No.: 19/244,432

(22) Filed: Jun. 20, 2025

Related U.S. Application Data
(60) Provisional application No. 63/662,592, filed on Jun. 21, 2024.

(51) Int. Cl. C09D 5/29; C08K 3/34; C08K 5/00; C08K 5/13; C08K 7/26; C09D 7/20; C09D 7/41; C09D 7/43; C09D 7/45; C09D 7/61; C09D 7/63; C09D 11/033; C09D 11/037; C09D 11/50

(52) U.S. Cl. CPC C09D 5/29; C09D 7/20; C09D 7/41; C09D 7/43; C09D 7/45; C09D 7/61; C09D 7/63; C09D 11/033; C09D 11/037; C09D 11/50; C08K 3/346; C08K 5/0041; C08K 5/13; C08K 7/26

(57) ABSTRACT

Colored compositions are provided. The colored compositions include at least one non-aqueous solvent, at least one leuco dye, at least one developer compound, and, optionally, at least one thickener and at least one solvent. The colored compositions as described herein may be decolored when exposed to water or a water-containing liquid.

### FIELD OF THE INVENTION

Embodiments generally relate to colored compositions, particularly to non-aqueous colored compositions that may be rendered colorless after exposure to water.

### BACKGROUND OF THE INVENTION

Art materials for the entertainment and developmental benefit of children are well-known. For example, colored compositions, such as inks and paints, are typically given to children to produce artwork and to stimulate the children's creativity and imagination. However, a significant drawback with conventional inks and paints is that they tend to become very messy in use. Even further, colorants used in inks and paints often stain the surfaces on which they are applied, and it may be difficult if not impossible to remove such stains. Indeed, parents often limit the use of inks and paints by children because of the possibility that household objects, such as carpets and furniture, as well as skin and clothing, would be stained by these compositions. Accordingly, much effort has been expended over many years to reduce or eliminate staining. For example, U.S. Pat. Nos. 5,417,748 and 6,124,377 are directed towards writing instruments that may reduce or eliminate stains. However, existing solutions often relate to inks requiring writing instruments to be used properly and may further include components deemed unsafe for children. A need therefore remains H for colored compositions that may easily, safely, and rapidly be washed from a substrate without leaving stains or unsightly marks.

### SUMMARY OF THE INVENTION

In exemplary embodiments, a colored composition includes at least one non-aqueous solvent; at least one leuco dye; at least one developer compound; optionally, at least one thickener; and optionally, at least one surfactant.

In some embodiments, the colored composition is configured to be applied to a substrate.

In some embodiments, the colored composition is further configured to be rendered into a colorless state when contacted with water after application to the substrate.

In some embodiments, the at least one non-aqueous solvent is present in an amount between about 75% and 95% by weight, the at least one leuco dye is present in an amount between about 0.014% and 6% by weight, and the at least one developer compound is present in an amount between about 0.2% and 5% by weight.

In some embodiments, the at least one thickener is present in an amount between 0% and 25% by weight.

In some embodiments, the at least one non-aqueous solvent is selected from the group consisting of triacetin, propylene carbonate, dimethylformamide (DMF), dimethylacetamide (DMAc), dimethyl sulfoxide (DMSO), acetone, methyl ethyl ketone (MEK), methyl ethoxypropionate, acetonitrile, glycerol carbonate, glycerin, propylene glycol, short chain alcohols, diesters, soybean oil, soybean oil methyl esters, volatile hydrocarbons, and mixtures thereof.

In some embodiments, the at least one non-aqueous solvent includes soybean oil methyl ester.

In some embodiments, the at least one leuco dye is selected from the group consisting of diarylphthalide dyes, fluoran dyes, indolyphthalide dyes, acylluecoazine dyes, leucoauramine dyes, spiropyran dyes, rhodaminelactam dyes, triarylmethane dyes, chromene dyes, substituted pyridine dyes, and mixtures thereof.

In some embodiments, the at least one leuco dye is selected from the group consisting of 3,3′-bis(1-n-octyl-2-methylindol-3-yl)phthalide, N,N-dimethyl-4-[2-(2-octoxyphenyl)-6 -phenylpyridin-4-yl]aniline, 7-[4-(diethylamino)-2-methylphenyl]-7-(1-ethyl-2-methylindol-3 -yl)furo[3,4-b]pyridin-5-one, 6-(dimethylamino)-3,3-bis(p-(dimethylamino)phenyl) phthalide, 2′ -(dibenzylamino)-6′-(diethylamino)fluoran, 6′-(diethylamino)-1′, 3′-dimethylfluoran, 2′-anilino-6′-(dibutylamino)-3′-methylfluoran and mixtures thereof.

In some embodiments, the at least one developer compound is selected from the group consisting of zinc salicylate, magnesium salicylate, aluminum salicylate, bismuth subsalicylate, salicylic acid, a metal salt of functionalized derivatives of salicylic acid, clays, a Lewis acid, phenols and phenolic resins, maleic acid, succinic acid, oxalic acid, phenylpropiolic acid and mixtures and/or derivatives thereof.

In some embodiments, the metal salt is selected from the group consisting of zinc acetate, zinc chloride, aluminum sulfate, and aluminum halides.

In some embodiments, the clay is selected from the group consisting of kaolin, montmorillonite, and bentonite.

In some embodiments, the Lewis acid is selected from the group consisting of aluminum sulfate, aluminum chloride, and aluminum phosphate.

In some embodiments, the at least one developer compound includes zinc salicylate.

In some embodiments, the at least one thickener includes fumed silica.

In some embodiments, the colored composition further includes at least one additive selected from the group consisting of preservatives, scent compounds, glitters, metallic effect particles, and mixtures thereof.

In some embodiments, the composition has a viscosity between 20 and 250,000 cP.

In some embodiments, the composition further includes a fragrance compound.

In some embodiments, the fragrance compound is present in an amount about 0.1% by weight.

In exemplary embodiments, a method of forming a colored composition includes mixing a first mixture including at least one non-aqueous solvent; at least one leuco dye; at least developer compound; optionally, at least one thickener; and optionally, at least one surfactant.

In some embodiments, the method further includes mixing at least one thickener and the first mixture.

In some embodiments, the step of mixing the at least one thickener and the first mixture includes mixing with a Cowles blade.

In some embodiments, the method further includes mixing at the least one additive and the first mixture, wherein the at least one additive is selected from the group consisting of preservatives, scent compounds, glitters, metallic effect particles, and mixtures thereof.

In exemplary embodiments, a paint includes a colored composition includes at least one non-aqueous solvent; at least one leuco dye; at least one developer compound; optionally, at least one thickener; and optionally, at least one surfactant.

In exemplary embodiments, an ink includes a colored composition includes at least one non-aqueous solvent; at least one leuco dye; at least one developer compound; optionally, at least one thickener; and optionally, at least one surfactant.

In exemplary embodiments, a colored composition includes at least one non-aqueous solvent; at least one leuco dye; at least developer compound; optionally, at least one thickener; and optionally, at least one surfactant, wherein the colored composition is configured to be rendered colorless when contacted with water.

In some embodiments, the at least one leuco dye is activated by the developer compound.

### DETAILED DESCRIPTION OF THE INVENTION

The following description is of exemplary embodiments and methods of use that are presently contemplated for carrying out the present invention. This description is not to be taken in a limiting sense but is made merely for the purpose of describing the general principles and features of various aspects of the present invention. The scope of the present invention is not limited by this description.

Unless defined otherwise, all technical and scientific terms used herein have the same meanings as commonly understood by one of ordinary skill in the art to which this invention belongs. Specific methods, devices, and materials are described, although any methods and materials similar or equivalent to those described herein can be used in the practice or testing of the present invention.

As used herein, the term “colored” or “colored state” refers to a composition or material that exhibits a hue, tint, or shade resulting from the absorption or reflection of certain wavelengths of light. The term indicates that the composition or material has a distinctive color that is observable by the human eye under normal lighting conditions.

As used herein, the term “colorless” or “colorless state” refers to a composition or material that lacks any discernible color or hue. The term indicates that the object appears transparent or translucent and does not exhibit any noticeable color when viewed by the human eye under normal lighting conditions.

As used herein, the term “decolor” means to transform a composition or material from a colored state to a colorless state.

As used herein, the term “clean” or “clean up” means to remove or eliminate, or to appear to remove or eliminate, colored compositions from a substrate. Specifically, the term denotes the act of restoring a substrate with a colored composition applied thereto to its original or desired condition in which the colored composition is or appears to be removed or eliminated.

The present invention relates to colored compositions, such as inks or paints. The colored compositions include at least one non-aqueous solvent, at least one leuco dye, at least one developer compound, and, optionally, at least one thickener and at least one solvent. It has been surprisingly found that the colored compositions according to the present invention may be decolored when exposed to water or a water-containing liquid. It has also been surprisingly found that thickened colored compositions do not leave either a visible or detectable-by-touch residue on substrates after the colored compositions are decolored by water or a water-containing liquid. The colored compositions may therefore clean significantly faster than existing compositions and without the need for organic solvents, soaps, or detergents, making clean up safer and easier.

The colored compositions include at least one suitable non-aqueous solvent. The solvents may be soybean oil, soybean oil methyl esters, triacetin, propylene carbonate, dimethylformamide (DMF), dimethylacetamide (DMAc), dimethyl sulfoxide (DMSO), acetone, methyl ethyl ketone (MEK), methyl ethoxypropionate, acetonitrile, glycerol carbonate, glycerin, propylene glycol, short chain alcohols (e.g., ethanol, isopropanol), diesters, volatile hydrocarbons (e.g., naphtha, mineral spirits), and mixtures thereof, or any other suitable non-aqueous solvent. It is contemplated that non-aqueous solvents with active hydrogens (e.g., propylene glycol, glycerin, isopropanol, etc.) may activate the leuco dyes to some degree. It is further contemplated that polar solvents (e.g., acetonitrile, dimethylacetamide, etc.) may be beneficial if organic developers, such as phenols or maleic acid, are used. In preferred embodiments, the solvents include soybean oil methyl esters.

The solvents can be present in the compositions in any suitable amount. Preferably, solvents are present from about 75% to about 95% by weight of the composition. More preferably, the solvents may be present from about 85% to about 93% by weight of the composition. Even more preferably, the solvents may be present from about 89% to about 91% by weight of the composition. It is contemplated that the non-aqueous solvent does not contain water and is not based on water.

The colored compositions include at least one suitable leuco dye. A leuco dye, also referred to as a color former dye or compound, is a compound that can reversibly switch between two chemical forms, such as a colored state and a colorless state. It is contemplated that leuco dyes may be activated or developed (e.g., caused to change from a colorless state to a colored state) by a developer compound. An inactivated or undeveloped leuco dye may therefore be in a colorless state. It is further contemplated that leuco dyes may revert to their inactivated or undeveloped state when exposed to water. Accordingly, it is contemplated that leuco dyes provided in a mixture with non-aqueous solvents (e.g., not containing water) and developer compounds may provide a colored mixture.

In some embodiments, more than one leuco dye may be combined in various amounts to provide for colors (e.g., brown) that may not be available in dye form.

Examples of suitable leuco dyes include, but are not limited to, diarylphthalide dyes, fluoran dyes, indolyphthalide dyes, acylluecoazine dyes, leucoauramine dyes, spiropyran dyes, rhodaminelactam dyes, triarylmethane dyes, chromene dyes, substituted pyridine dyes, and mixtures thereof or any other suitable leuco dye. More specific leuco dyes include, but are not limited to 6′-(diethylamino)-2′-[(2,4-dimethylphenyl)amino]-3′-methyl-spiro [isobenzofuran-1(3H),9′-[9H]xanthen]-3-one[CAS 36431-22-8], 9-(diethylamino)-spiro[12H-benzo[a]xanthene-12,1′(3′H)-isobenzofuran]-3′-one [CAS 26628-47-7], 6′-(dibutylamino)-3′-methyl-2′-(phenylamino)-spiro[isobenzofuran-1(3H),9′-[9H]xanthen]-3-one [CAS 89331-94-2], 2′-[bis(phenylmethyl)amino]-6′-(diethylamino)-spiro[isobenzofuran-1(3H),9′-[9H]xanthen]-3-one [CAS 34372-72-0], 3,3′-bis(1-n-octyl-2-methylindol-3-yl)phthalide [CAS 50292-95-0], N,N-dimethyl-4-[2-(2-octoxyphenyl)-6-phenylpyridin-4-yl]aniline [CAS 144190-25-0], 7-[4-(diethylamino)-2-methylphenyl]-7-(1-ethyl-2-methylindol-3-yl)furo[3,4-b]pyridin-5-one [CAS 114090-18-5], 6-(dimethylamino)-3,3-bis(p-(dimethylamino)phenyl)phthalide [CAS 1552-42-7] 6′-(diethylamino)-1′, 3′-dimethylfluoran [CAS 21934-68-9], and mixtures thereof or any other suitable leuco dye. Leuco dyes are well-known in the art, and additional examples are described in, for example, Chemistry and Applications of Leuco Dyes, Muthyala, Ramaiha, ed.; Kluwer Academic Publishers, New York; ISBN: 0-306-45459-9, the entire contents of which are incorporated herein by reference.

Preferably, leuco dyes include 3,3′-bis(1-n-octyl-2-methylindol-3-yl)phthalide [CAS 50292-95-0], N,N-dimethyl-4-[2-(2-octoxyphenyl)-6-phenylpyridin-4-yl]aniline [CAS 144190-25-0], 7-[4-(diethylamino)-2-methylphenyl]-7-(1-ethyl-2-methylindol-3-yl)furo[3,4-b]pyridin-5-one [CAS 114090-18-5], 6-(dimethylamino)-3,3-bis(p-(dimethylamino)phenyl)phthalide [CAS 1552-42-7], 2′-[bis(phenylmethyl)amino]-6′-(diethylamino)-spiro[isobenzofuran-1 (3H), 9′-[9H]xanthen]-3-one [CAS 34372-72-0], 6′-(diethylamino)-1′, 3′-dimethylfluoran [CAS 21934-68-9], 6′-(dibutylamino)-3′-methyl-2′-(phenylamino)-spiro[isobenzofuran-1 (3H),9′-[9H]xanthen]-3-one [CAS 89331-94-2], and mixtures thereof.

The leuco dyes can be present in the compositions in any suitable amount. Preferably, the leuco dyes are present from about 0.014% to about 6% by weight of the composition. More preferably, the leuco dyes are present from about 0.2% to about 5% by weight of the composition. Even more preferably, the leuco dyes are present from about 0.5% to about 3% by weight by weight of the composition.

The colored compositions also include at least one suitable developer compound. As described above, the developer compounds may be configured to activate or develop the leuco dyes (e.g., cause to change from a colorless to a colored state). In the absence of the developer compounds, the leuco dyes may remain in their colorless states.

The developer compounds may be polyvalent metal salicylates, including but not limited to zinc salicylate, magnesium salicylate, aluminum salicylate, and bismuth subsalicylate. The developer compounds may also be metal salts of functionalized derivatives of salicylic acid, inorganic salts of polyvalent metals (such as zinc acetate, zinc chloride, aluminum sulfate, aluminum halides), salicylates and their derivatives, clays (such as kaolin, montmorillonite, and bentonite), Lewis acids (such as aluminum sulfate, aluminum chloride, aluminum phosphate, or any other suitable Lewis acid), and acidic organic compounds (such as phenols and phenolic resins, salicylic acid, maleic acid, succinic acid, oxalic acid, phenylpropiolic acid, citric acid, and glutaric acid) and derivatives and/or mixtures thereof, or any other suitable developer compounds. In preferred embodiments, the developer compound may be zinc salicylate. In other preferred embodiments, the developer compounds may include zinc salicylate and acidic organic compounds and/or Lewis acids.

The developer compounds can be present in the compositions in any suitable amount. Preferably, the developer compounds are present from about 0.2% to about 5% by weight of the composition. More preferably, the developer compounds are present from about 0.3% to about 2% by weight of the composition. Even more preferably, the developer compounds are present in an amount of about 0.5% by weight of the composition.

The colored compositions can optionally include at least one thickener. Thickeners may be fumed silica. It is contemplated that thickeners may adjust the viscosity of the compositions to a desired level. For example, increasing the amount of thickener present in a composition may increase the viscosity of the composition. The viscosity of the compositions is not particularly limited and may range from less than 20 cP to greater than 500,000 cP measured using a Brookfield LV Viscometer. Thickeners can be present in the compositions in any suitable amount. The compositions may not include thickeners at all, as thickeners are optional. Preferably, the thickeners are present from about 0% to about 25% by weight of the composition. More preferably, the thickeners are present in an amount of about 7% by weight of the composition.

The colored compositions can optionally include at least one surfactant. Examples of surfactants include compounds that enable water to better interact with the compositions, particularly with the leuco dyes. The surfactants may therefore increase the speed of the decolorization process. Any suitable surfactant may be used, and surfactants can be present in the compositions in any suitable amount. The compositions may not include surfactants at all, as surfactants are optional.

The colored compositions can optionally include at least one fragrance compound. It is contemplated that the fragrance compounds may be configured to improve the scent or smell of the compositions, for example, by masking the scents or smells of other components of the composition. Fragrance compounds can be present in the compositions in any suitable amount. The compositions may not include fragrance compounds at all, as fragrance compounds are optional. Preferably, the fragrance compounds are present from about 0% to about 0.2% by weight of the composition. Even more preferably, the fragrance compounds may be present at about 0.1% by weight of the composition.

The colored compositions can optionally include at least one preservative compound. Preservative compounds may be biocidal preservatives, fungicidal preservatives, or any other suitable preservatives and mixtures thereof. It is contemplated that preservative compounds may be configured to prevent the compositions from spoiling, particularly in light of the non-aqueous solvents. Preservative compounds can be present in the compositions in any suitable amount. The compositions may not include preservative compounds at all, as preservative compounds are optional.

It is contemplated that compositions can further optionally include one or more additional components, such as glitters and metallic effect particles. It is contemplated that the additional components may be configured to enhance the visual effects of the compositions before and after application of the compositions onto a substrate.

The present invention also relates to methods of forming the colored compositions described herein. In certain embodiments, methods may include combining at least one leuco dye with at least one non-aqueous solvent to form a first mixture. At least one developer compound may be combined with the first mixture to form a second mixture. It is contemplated that the leuco dye may be thoroughly dispersed in the solvents prior to addition of the developer compounds. At least one thickener may be optionally combined with the second mixture to reach a desired viscosity. At least one surfactant may also be optionally combined with the second mixture. At least one preservative may also be optionally combined with the second mixture. One or more additional components may also be optionally combined with the second mixture. It is contemplated that combining various components may include adding or mixing the components to form a mixture. It is further contemplated that any suitable mixing apparatus may be used to combine the components. Preferably, a Cowles blade is used to combine the thickeners with other components for efficiency. Alternatively, a magnetic stir bar or manual mixing (e.g., with a spatula) may be used to combine components. It is contemplated that while the leuco dyes may be readily soluble in the solvents, adding a thickener may require slightly more mixing to ensure even dispersion.

In certain embodiments, the order of addition of the components is not particularly limited, and the order presented above is only exemplary. For example, it is contemplated that at least one leuco dye may advantageously be combined with at least one developer prior to combination with at least one solvent, as this may result in a lower viscosity mixture. In certain embodiments, optional components (e.g., thickeners, surfactants, preservatives, additional components) may be added at any time in the manufacturing process.

It is contemplated that if the at least one leuco dye is added prior to the at least one developer compound, color development (e.g., activation of the leuco dye) may happen immediately or almost immediately after addition of the developer. Similarly, if the at least developer compound is added prior to the at least one leuco dye, color development (e.g., activation of the leuco dye) may happen immediately or almost immediately after addition of the leuco dye. However, it is contemplated that the speed of color development is not a critical aspect of the described colored compositions.

The present invention also relates to methods of using the colored compositions described herein. Colored compositions may be applied to any substrate capable of being coated with the composition. Exemplary substrates include but are not limited to paper, cardboard, fabrics, carpet, metal, wood, glass, plastic, or any other suitable substrate. It is contemplated that compositions may be applied to a substrate using any suitable instrument. For example, colored compositions may be applied using a brush, roll, spray can or gun, marker, pen, or any other suitable instrument. It is contemplated that an application method may be dependent, at least in part, on the viscosity of a composition. In certain embodiments, the compositions may also be applied to a substrate using a finger or hand.

After application to a substrate, colored compositions may be rendered colorless by applying water or a water containing liquid (e.g., tap water) to the compositions. It is contemplated that water deactivates developed leuco dyes that effectuate a change from the leuco dyes colored state to their colorless state. It is contemplated that colored compositions may be rendered colorless within 5 seconds, 1 second, or even immediately after application of water to the compositions.

In certain embodiments, the water may need to be physically worked into the substrate

after application. For example, if the substrate is a carpet, water may need to be worked into the carpet pile using a brush or any other suitable tool.

It is contemplated that the colored compositions may be rendered colorless without the need for compositions outside of water, such as organic solvents, soaps, and detergents. It is therefore contemplated that cleaning-up the colored compositions may be safer than cleaning up other compositions. Additionally, as water is often more readily available than other cleaning products, cleaning up the colored compositions may be easier than cleaning up other compositions.

It is contemplated that while components of the colored compositions may remain or be physically present on a substrate after application of water, the absence of color signifies to a consumer that the composition has been removed and cleaned up.

### EXAMPLES

Exemplary compositions according to the disclosure provided herein were prepared. Compositions were prepared by mixing the solvents, leuco dyes, developer compounds, surfactants, and thickeners identified in Table 1 at amounts (in weight percentage) identified in the table. Chemical names related to exemplary leuco dye colors that may be used are presented in Table 2.

TABLE 1

| | Red | Orange | Yellow | Green | Blue | Purple |
|---|---|---|---|---|---|---|
| Component | Comp. | Comp. | Comp. | Comp. | Comp. | Comp. |
| Soyclear 1500 | 81.00 | 81.00 | 81.00 | 81.00 | 81.00 | 81.00 |
| (solvent) | | | | | | |
| Triacetin | 8.00 | 8.00 | 8.00 | 8.00 | 8.00 | 8.00 |
| (solvent) | | | | | | |
| Surfonyl 420 | 3.00 | 3.00 | 3.00 | 3.00 | 3.00 | 3.00 |
| (surfactant) | | | | | | |
| Zinc Salicylate | 0.50 | 0.50 | 0.50 | 0.50 | 0.50 | 0.50 |
| (developer) | | | | | | |
| Red leuco dye | 0.174 | 0.000 | 0.000 | 0.000 | 0.000 | 0.310 |
| Orange leuco | 0.308 | 0.500 | 0.000 | 0.000 | 0.000 | 0.000 |
| dye | | | | | | |
| Yellow | 0.000 | 0.000 | 0.500 | 0.500 | 0.000 | 0.000 |
| leuco dye | | | | | | |
| Blue leuco dye | 0.014 | 0.000 | 0.000 | 0.000 | 0.500 | 0.190 |
| Aerosil 200 | 7.00 | 7.00 | 7.00 | 7.00 | 7.00 | 7.00 |
| (thickener) | | | | | | |
| | 100.00 | 100.00 | 100.00 | 100.00 | 100.00 | 100.00 |

TABLE 2

| Color | CAS | Chemical Name |
|---|---|---|
| Red | 50292-95-0 | 3,3′-bis(1-n-octyl-2-methylindol-3-yl)phthalide |
| Yellow | 144190-25-0 | N,N-dimethyl-4-[2-(2-octoxyphenyl)-6-phenylpyridin-4- |
| | | yl]aniline |
| Cyan | 114090-18-5 | 7-[4-(diethylamino)-2-methylphenyl]-7-(1-ethyl-2- |
| | | methylindol-3-yl)furo[3,4-b]pyridin-5-one |
| Blue | 1552-42-7 | 6-(dimethylamino)-3,3-bis(p- |
| | | (dimethylamino)phenyl)phthalide |
| Green | 34372-72-0 | 2′-[bis(phenylmethyl)amino]-6′-(diethylamino)- |
| | | spiro[isobenzofuran-1(3H),9′-[9H]xanthen]-3-one |
| Orange | 21934-68-9 | 6′-(diethylamino)-1′,3′-dimethylfluoran |
| Black | 89331-94-2 | 6′-(dibutylamino)-3′-methyl-2′-(phenylamino)- |
| | | spiro[isobenzofuran-1(3H),9′-[9H]xanthen]-3-one |

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A colored composition, comprising:
at least one non-aqueous solvent;
at least one leuco dye;
at least one developer compound;
optionally, at least one thickener; and
optionally, at least one surfactant.

2. The colored composition of claim 1, wherein the colored composition is configured to be applied to a substrate.

3. The colored composition of claim 2, wherein the colored composition is further configured to be rendered into a colorless state when contacted with water after application to the substrate.

4. The colored composition of claim 1, wherein the at least one non-aqueous solvent is present in an amount between about 75% and 95% by weight, the at least one leuco dye is present in an amount between about 0.014% and 6% by weight, and
the at least one developer compound is present in an amount between about 0.2% and 5% by weight.

5. The colored composition of claim 4, wherein
the at least one thickener is present in an amount between 0% and 25% by weight.

6. The colored composition of claim 1, wherein the at least one non-aqueous solvent is selected from the group consisting of triacetin, propylene carbonate, dimethylformamide (DMF), dimethylacetamide (DMAc), dimethyl sulfoxide (DMSO), acetone, methyl ethyl ketone (MEK), methyl ethoxypropionate, acetonitrile, glycerol carbonate, glycerin, propylene glycol, short chain alcohols, diesters, soybean oil, soybean oil methyl esters, volatile hydrocarbons, and mixtures thereof.

7. The colored composition of claim 1, wherein the at least one non-aqueous solvent comprises soybean oil methyl ester.

8. The colored composition of claim 1, wherein the at least one leuco dye is selected from the group consisting of diarylphthalide dyes, fluoran dyes, indolyphthalide dyes, acylluecoazine dyes, leucoauramine dyes, spiropyran dyes, rhodaminelactam dyes, triarylmethane dyes, chromene dyes, substituted pyridine dyes, and mixtures thereof.

9. The colored composition of claim 8, wherein the at least one leuco dye is selected from the group consisting of 3,3′-bis(1-n-octyl-2-methylindol-3-yl)phthalide, N,N-dimethyl-4-[2-(2-octoxyphenyl)-6-phenylpyridin-4-yl]aniline, 7-[4-(diethylamino)-2-methylphenyl]-7-(1-ethyl-2-methylindol-3-yl)furo[3,4-b] pyridin-5-one, 6-(dimethylamino)-3,3-bis(p-(dimethylamino)phenyl)phthalide, 2′-(dibenzylamino)-6′-(diethylamino)fluoran, 6′-(diethylamino)-1′,3′-dimethylfluoran, 2′-anilino-6′-(dibutylamino)-3′-methylfluoran and mixtures thereof.

10. The colored composition of claim 1, wherein the at least one developer compound is selected from the group consisting of zinc salicylate, magnesium salicylate, aluminum salicylate, bismuth subsalicylate, salicylic acid, a metal salt of functionalized derivatives of salicylic acid, clays, a Lewis acid, phenols and phenolic resins, maleic acid, succinic acid, and mixtures and/or derivatives thereof.

11. The colored composition of claim 10, wherein the metal salt is selected from the group consisting of zinc acetate, zinc chloride, aluminum sulfate, and aluminum halides.

12. The colored composition of claim 10 wherein the clay is selected from the group consisting of kaolin, montmorillonite, and bentonite.

13. The colored composition of claim 10, wherein the Lewis acid is selected from the group consisting of aluminum sulfate, aluminum chloride, and aluminum phosphate.

14. The colored composition of claim 1, wherein the at least one developer compound comprises zinc salicylate.

15. The colored composition of claim 1, wherein the at least one thickener comprises fumed silica.

16. The colored composition of claim 1, further comprising at least one additive selected from the group consisting of preservatives, scent compounds, glitters, metallic effect particles, and mixtures thereof.

17. The colored composition of claim 1, wherein the composition has a viscosity between 20 and 500,000 cP.

18. The colored composition of claim 1, wherein the composition further comprises a fragrance compound.

19. The colored composition of claim 18, wherein the fragrance compound is present in an amount about 0.1% by weight.

20. A method of forming a colored composition, comprising:
mixing a first mixture comprising:
at least one non-aqueous solvent;
at least one leuco dye;
at least developer compound;
optionally, at least one thickener; and
optionally, at least one surfactant.

21. The method of claim 20, further comprising:
mixing at least one thickener and the first mixture.

22. The method of claim 21, wherein the step of mixing the at least one thickener and the first mixture includes mixing with a Cowles blade.

23. The method of claim 20, further comprising:
mixing at the least one additive and the first mixture, wherein the at least one additive is selected from the group consisting of preservatives, scent compounds, glitters, metallic effect particles, and mixtures thereof.

24. A paint comprising the colored composition of claim 1.

25. A colored ink or paint system, comprising:
at least one non-aqueous solvent;
at least one leuco dye;
at least developer compound;
optionally, at least one thickener; and
optionally, at least one surfactant,
wherein the colored ink or paint composition is configured to be rendered colorless when contacted with water.

26. The colored ink or paint system of claim 25, wherein the at least one leuco dye is activated by the developer compound.
